(19) United States
(12) Patent Application Publication
(10) Pub. No.: US 2014/0156307 A1
(43) Pub. Date: Jun. 5, 2014

(54) MEDICAL IMAGE SYSTEM

(71) Applicant: KONICA MINOLTA, INC., Tokyo (JP)

(72) Inventor: Ryuuji MASUDA, Tokyo (JP)

(73) Assignee: KONICA MINOLTA, INC., Tokyo (JP)

(21) Appl. No.: 14/092,620

(22) Filed: Nov. 27, 2013

(30) Foreign Application Priority Data
Dec. 5, 2012 (JP) 2012-265881

(51) Int. Cl. G06F 19/00

(52) U.S. Cl. CPC G06F 19/321
USPC 705/3

(57) ABSTRACT

Disclosed is a medical image system including a medical image management apparatus including a storage unit, a plurality of client terminals and an image generation apparatus. The medical image management apparatus includes an image management unit which stores a medical image which is sent from the image generation apparatus according to an image import instruction, provides the client terminal which gave the image import instruction with the medical image, and when an instruction to approve the medical image stored in the storage unit is given from the client terminal, stores information indicating that the medical image is approved and allows the medical image which is approved to be viewed by other client terminals. Each client terminal includes an automatic approval unit which automatically approves the unapproved medical image, and a notifying unit which notifies information indication existence of the medical image which is automatically approved.

### BACKGROUND OF THE INVENTION

1. Field of the Invention

The present invention relates to a medical image system.

2. Description of Related Art

In recent years, medical image management apparatuses which import medical images generated by various types of image generation apparatuses and which store the imported medical images in image DBs (Data Bases) to manage them are used in the medical field (see JP 2010-124943).

In a system including such medical image management apparatus (server apparatus) and client terminals, logging in to the system via a login screen is performed and a patient who is the target for image capturing is selected in a search screen among the patients who went through the reception on that day at a client terminal, and then, the screen switches to an image display screen of the patient who is the target for image capturing. When the image import button in the image display screen is pushed, the image generation apparatus corresponding to the image import button and the medical image management apparatus be in the online state, and the medical image management apparatus be on standby to import images from the image generation apparatus. When image capturing is performed on the patient who is the target for image capturing with the image generation apparatus, the medical image which is generated by the image generation apparatus is imported in to the medical image management apparatus. At the client terminal, a user refers to the medical image that is imported in to the medical image management apparatus and whether the image is suited for making a diagnosis is judged. If it is judged that the image is suited for making a diagnosis (OK), that is, if the image is approved, the medical image can also be viewed by other client terminals in the system. On the other hand, if it is judged that the image is not suited for making a diagnosis (NG), the medical image is destroyed.

With regard to a medical image which is imported by making an image generation apparatus be in the online state according to the image import instruction from a client terminal, whether the image is suited for making a diagnosis (OK/NG) can only be decided at the corresponding client terminal. That is, in a case where a medical image is imported in to the medical image management apparatus from an image generation apparatus and the judgment whether the medical image is OK/NG remains not completed (not approved) at the corresponding client terminal, this medical image cannot be viewed by other client terminals.

For example, because apparatuses such as tablet type terminals which perform data communication via wireless LAN (Local Area Network) or the like are being increasingly used as client terminals, there is a risk that the communication with the medical image management apparatus may be unstable temporarily. After a medical image generated in the image generation apparatus is imported in to the medical image management apparatus, if the communication between the client terminal and the medical image management apparatus is cutoff before a user views the medical image or before judging whether the medical image is OK/NG, there is a possibility that the condition of being logged in to the system terminates while the medical image remains unapproved.

Further, after a medical image generated with the image generation apparatus is imported in to the medical image management apparatus, if a user leaves the image without judging whether the image is OK/NG at the client terminal, the screen will be switched to the login screen due to session timeout.

If an unapproved medical image is automatically approved, such medical image can be made available to other client terminals. However, there is a problem that a user cannot recognize that there is a medical image that is automatically approved. If the images that were approved automatically and the images that were intentionally approved by a physician are mixed in the medical images which are made available to other client terminals, the degree of reliability of each image is hard to tell.

### SUMMARY OF THE INVENTION

In view of the above problems, an object of the present invention is to alert a user when medical images that are automatically approved are mixed in.

In order to solve the above problems, according to one aspect to the present invention, a medical image system includes a medical image management apparatus including a storage unit, a plurality of client terminals and an image generation apparatus, and the medical image management apparatus and the plurality of client terminals are connected to one another to perform data communication therebetween, the medical image management apparatus and the image generation apparatus are connected to one another to perform data communication therebetween, the medical image management apparatus includes an image management unit which (i) stores a medical image which is sent from the image generation apparatus in the storage unit according to an image import instruction from each of the plurality of client terminals, (ii) provides the client terminal which gave the image import instruction with the medical image stored in the storage unit, (iii) when an instruction to approve the medical image stored in the storage unit is given from the client terminal which gave the image import instruction, stores information indicating that the medical image is approved in the storage unit so as to be associated with the medical image and allows the medical image which is approved to be viewed by other client terminals, and each of the plurality of client terminals includes an automatic approval unit which, when an unapproved medical image exists among medical images which are stored in the storage unit according to the image import instruction from the client terminal, automatically approves the unapproved medical image and a notifying unit which, when the medical image which is automatically approved exists among the medical images which are stored in the storage unit according to the image import instruction from the client terminal, notifies information indication existence of the medical image which is automatically approved.

According to the present invention, a user can be alerted if medical images that are automatically approved exist.

Preferably, the image management unit stores information indicating automatic approval in the storage unit so as to be associated with the medical image which is automatically approved and allows the medical image which is automatically approved to be viewed by other client terminals.

Preferably, each of the plurality of client terminals further includes a display control unit which, when the medical image which is automatically approved exists among the medical images which are stored in the storage unit according to the image import instruction from the client terminal, displays an automatically approved medical image list in a display unit, an operating unit for selecting a medical image whose automatic approval is to be confirmed among the list displayed in the display unit, and a reconfirmation unit which sends an instruction to store a medical image whose automatic approval is confirmed in the storage unit so as to be associated with information indicating that the automatic approval of the medial image is confirmed.

Preferably, the data communication between the medical image management apparatus and the plurality of client terminals is performed in a wireless manner.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a system configuration diagram of a medical image system according to the embodiment of the present invention;

FIG. 2 is a block diagram showing a functional configuration of a medical image management apparatus;

FIG. 3 is an example of a device management table;

FIG. 4 is an example of an image management table;

FIG. 5 is a block diagram showing a functional configuration of a client terminal;

FIG. 6 is a ladder chart showing an image import process at normal operation;

FIG. 7 is an example of a login screen;

FIG. 8 is an example of a search screen;

FIG. 9 is an example of an image display screen before an image is imported;

FIG. 10 is an example of an image display screen where an image is displayed;

FIG. 11 is a flowchart showing an unapproved image check process;

FIG. 12 is a flowchart showing an automatically approved image notifying process;

FIG. 13 is an example of a search screen in which a warning icon is displayed; and

FIG. 14 is an example of an automatically approved image list screen.

### DESCRIPTION OF THE PREFERRED EMBODIMENTS

Hereinafter, an embodiment of a medical image system according to the present invention will be described with reference to the drawings. However, the present invention is not limited to the examples shown in the drawings.

### [Configuration of Medical Image System]

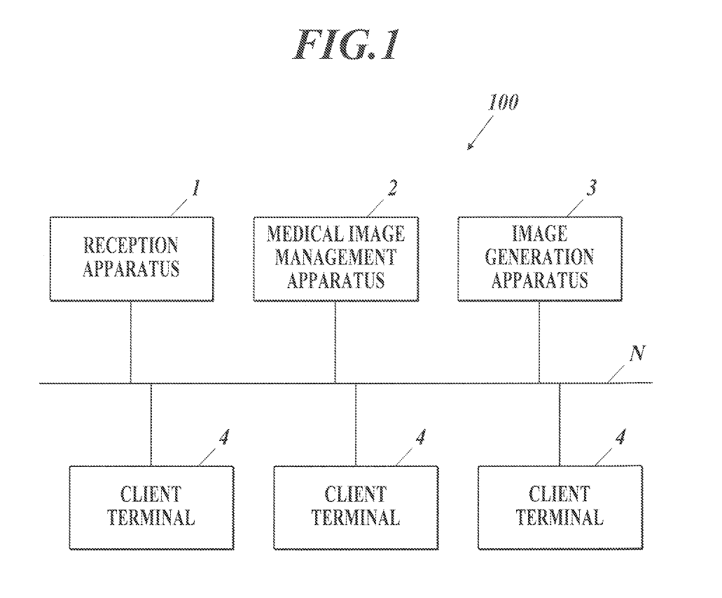

FIG. 1 shows a system configuration of the medical image system 100. The medical image system 100 includes a reception apparatus 1, a medical image management apparatus 2, an image generation apparatus 3 and a plurality of client terminals 4, for example. Each apparatus which constitutes the medical image system 100 is connected to a communication network N such as LAN via a switching hub (not shown in the drawing), for example. In particular, the medical image management apparatus 2 and the plurality of client terminals 4 are connected to one another via the communication network N so that data communication can be carried out therebetween, and the medical image management apparatus 2 and the image generation apparatus 3 are connected to one another via the communication network N so that data communication can be carried out therebetween.

As for the communication method within a hospital, the DICOM (Digital Image and Communication in Medicine) standard is generally used. The DICOM MWM (Modality Worklist Management) or the DICOM MPPS (Modality Performed Procedure Step) is used for communication between the apparatuses which are connected through LAN. Here, the communication method that can be applied to the embodiment is not limited to what is described above.

The reception apparatus 1 is a computer apparatus for carrying out reception and registration of patients who visit the hospital, payment calculation and insurance point calculation, for example. When reception information (reception number, patient's name and the like) is input into the reception apparatus 1, patient information of a patient who went through the reception is stored in the reception apparatus 1 and the reception apparatus 1 provides an external device with patient information of a patient who went through the reception upon a request from the external device.

The medical image management apparatus 2 manages the medical images which are generated in the image generation apparatus 3 in association with the patient information and provides an external device with the medical images and the patient information upon a request from the external device.

The image generation apparatus 3 performs image capturing by setting a body part of a patient who is the target for diagnosis as the subject and generates a medical image by performing digital conversion on the captured image. The image generation apparatus 3 includes a DR (Digital Radiography) apparatus, a CR (Computed Radiography) apparatus and an ultrasound diagnostic apparatus (US), for example. The image generation apparatus 3 attaches patient information (patient ID, patient name, gender, date of birth, age, etc.) and image attribution information (UID, date of image capturing, examination ID, examined part, etc.) to medical images.

Each client terminal 4 is a computer apparatus for giving instructions regarding importing of medical images from the image generation apparatus 3 in the medical image management apparatus 2 and viewing of medical images managed by the medical image management apparatus 2. Each client terminal 4 is configured with a tablet type terminal or the like, and data communication between each client terminal 4 and the medical image management apparatus 2 is performed in a wireless manner.

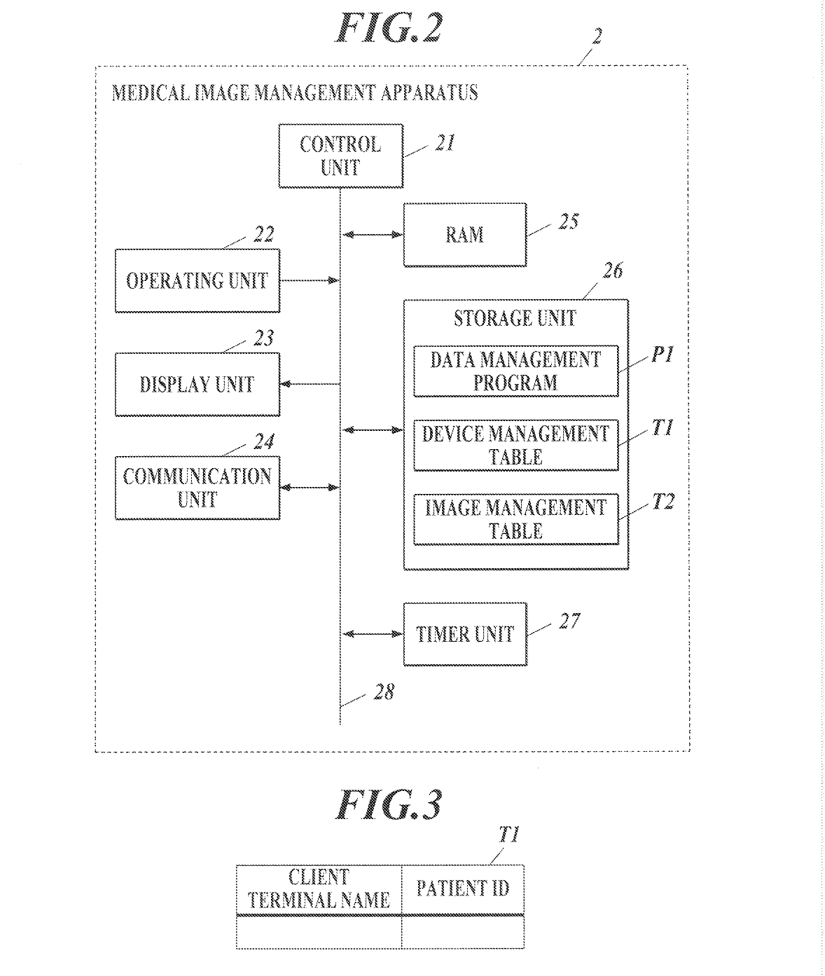

FIG. 2 shows a functional configuration of the medical image management apparatus 2. As shown in FIG. 2, the medical image management apparatus 2 includes a control unit 21, an operating unit 22, a display unit 23, a communication unit 24, a RAM (Random Access Memory) 25, a storage unit 26 and a timer unit 27, for example. These units are connected to one another by a bus 28.

The control unit 21 is configured with a CPU (Central Processing Unit), for example. The control unit 21 reads out various types of programs such as a system program and processing programs which are stored in the storage unit 26 and opens them in the RAM 25 to execute various types of processing according to the opened programs.

The operating unit 22 is configured by including a key board including character input keys, number input keys and various function keys, for example, and a pointing device such as a mouse. The operating unit 22 outputs push signals of the keys in the key board that are pushed and operation signals of the mouse to the control unit 21 as input signals.

The display unit 23 is configured with a LCD (Liquid Crystal Display), for example. The display unit 23 displays various types of screens according to the instructions of display signals which are input from the control unit 21.

The communication unit 24 is configured with a network interface, for example. The communication unit 24 performs sending and receiving of data with an external device which is connected to the communication network N.

The RAM 25 functions as a work area for temporarily storing various types of programs read out from the storage unit 26 that can be executed by the control unit 21, input and output data and the like in various processing which are executed and controlled by the control unit 21.

The storage unit 26 is configured with a HDD (Hard Disk Drive) memory or a non-volatile memory such as a semiconductor memory, etc. In the storage unit 26, various programs, data necessary for various processing and the like are stored. For example, in the storage unit 26, the data management program P1, the device management table T1, the image management table T2, medical images and the like are stored.

FIG. 3 shows an example of the device management table T1. The device management table T1 is a table for managing the information regarding the client terminal 4 which gave the image import instruction. In the device management table T1, “client terminal name” and “patient ID” are stored so as to be associated to each other.

In the field of “client terminal name”, the client terminal name (for example, IP address) of the client terminal 4 which gave the image import instruction is stored.

In the field of “patient ID”, the patient ID of a patient who is the target for image capturing is stored.

When the image import instruction is given by any of the client terminals 4, values are stored in the field of “client terminal name” and the field of “patient ID” of the device management table T1. Thereafter, when an image is imported in to the medical image management apparatus 2 from the image generation apparatus 3 based on the image import instruction, the field of “client terminal name” and the field of “patient ID” of the device management table T1 return to “NULL”. Here, only when the field of “client terminal name” and the field of “patient ID” of the device management table T1 are “NULL”, the medical image management apparatus 2 is able to accept the image import instruction. The field of “client terminal name” and the field of “patient ID” in the device management table T1 may automatically return to “NULL” after a predetermined time period elapses since the image import instruction is given.

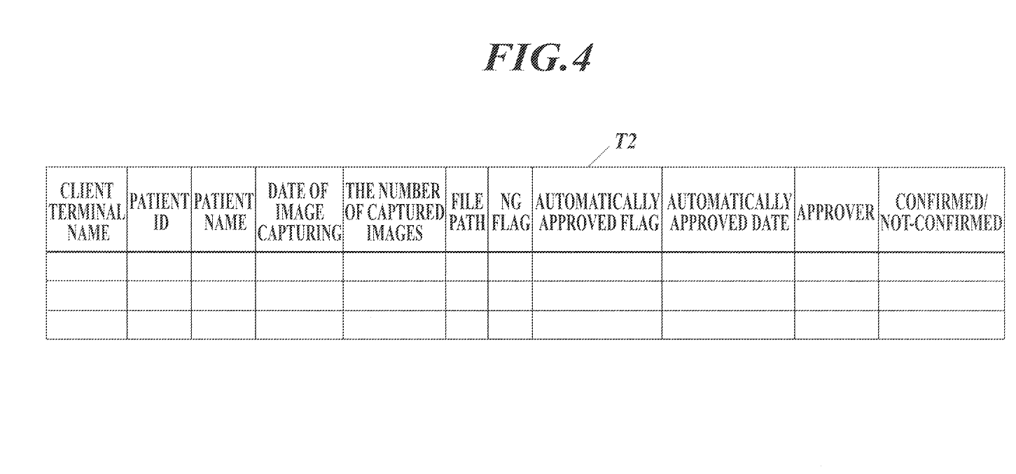

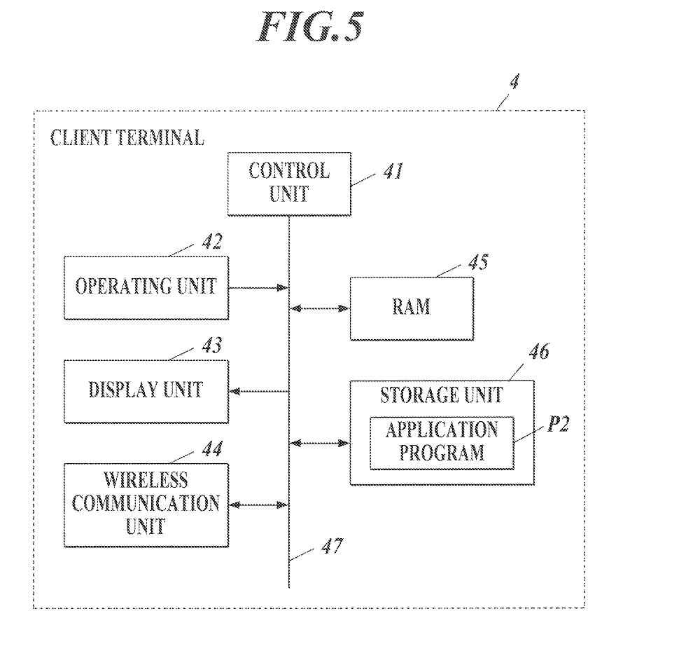

FIG. 4 shows an example of the image management table T2. The image management table T2 is a table for managing information regarding medical images. In the image management table T2, “client terminal name”, “patient ID”, “patient name”, “date of image capturing”, “the number of captured images”, “file path”, “NG flag”, “automatically approved flag”, “date of automatic approval”, “approver” and “confirmed/not confirmed”, for example, are stored as one record by being associated to one another.

For each record, in the field of “client terminal name”, the client terminal name (for example, IP address) of the client terminal 4 which gave the image import instructions is stored. If the subject image is approved (if “NG flag” becomes “0:OK”), the field of “client terminal name” returns to “NULL” regardless of whether the image was approved normally or automatically.

For each record, in the field of “patient ID”, the patient ID of a patient who is the target for image capturing is stored.

For each record, in the field of “patient name”, the patient name (Ascii, Kana characters, Kanji characters) of the patient who is the target for image capturing is stored.

For each record, in the field of “date of image capturing”, the date when the subject image was captured is stored.

For each record, in the field of “the number of captured images”, the number of subject images that were captured is stored.

For each record, in the field of “file path”, the file path indicating the storage place of the file of the subject image is stored.

For each record, in the field of “NG flag”, information indicating whether the subject image is approved or not is stored. If the subject image is approved, “0: OK” is stored. If the subject image is not approved, “NULL” is stored.

For each record, in the field of “automatically approved flag”, information indicating whether the subject image is automatically approved (hereinafter, also referred to as automatic approval) is stored. If the subject image is automatically approved, “1: automatic approval” is stored. If the subject image is not automatically approved, “NULL” is stored.

For each record, in the field of “date of automatic approval”, the date when the subject image was automatically approved, if the subject image was automatically approved, is stored.

For each record, in the field of “approver”, the user ID of a user who was logged in when the subject image was automatically approved is stored.

For each record, in the field of “confirmed/not confirmed”, information indicating whether the medical image which was automatically approved is confirmed by the user. If the medical image which was automatically approved is confirmed, “1: confirmed” is stored. If the medical image which was automatically approved is not confirmed, “0: not confirmed” is stored.

The timer unit 27 is configured with RTC (Real Time Clock) or the like. The timer unit 27 keeps record of the current time and the current date, and outputs the information to the control unit 21.

The control unit 21, based on the image import instruction from each client terminal 4, stores a medical image(s) which is sent from the image generation apparatus 3 in the storage unit 26. The control unit 21 provides the client terminal 4, which gave the image import instruction, with the medical image(s) stored in the storage unit 26. If the client terminal 4, which gave the image import instruction, gives an approval instruction with respect to the medical image(s) stored in the storage unit 26, the control unit 21 stores the medical image(s) in the storage unit 26 with the information indicating that the medical image(s) is approved (“0: OK” in the field of “NG flag” in the image management table T2) associated thereto and allows the approved medical image(s) to be viewed by other client terminals 4. That is, the control unit 21 functions as an image management unit.

The control unit 21 stores the information indicating that the medical image(s) is automatically approved (“1: automatic approval” in the field of “automatically approved flag”) in the storage unit 26 so as to be associated with the medical image(s) which is automatically approved (hereinafter, referred to as the automatically approved image) and allows the automatically approved image(s) to be viewed by other client terminals 4.

In particular, the control unit 21 refers to the image management table T2 which is stored in the storage unit 26 and allows the medical image(s) whose field of “NG flag” has “0: OK” stored therein be view by all of the client terminals 4. On the other hand, with respect to the medical image(s) whose field of “NG flag” has “NULL” stored therein, the control unit 21 allows the medical image(s) be viewed only by the client terminal 4 corresponding to the client terminal name stored in the field of “client terminal name” relating to the medical image(s) in the image management table T2.

FIG. 5 shows a functional configuration of each client terminal 4. As shown in FIG. 5, each client terminal 4 includes a control unit 41, an operating unit 42, a display unit 43, a wireless communication unit 44, a RAM 45 and a storage unit 46, for example. These units are connected to one another by a bus 47.

The control unit 41 is configured with a CPU or the like. The control unit 41 reads out various programs such as a system program and processing programs which are stored in the storage unit 46, opens the programs in the RAM 45 and executes various processes according to the programs that are opened.

The operating unit 42 is configured by including operation keys such as a power key which turns the power on/off and a touch panel which is layered on the display unit 43. The operating unit 42 outputs operation signals corresponding to the operation keys and operation signals according to the positions where touching operation was performed by, for example, a finger of a user to the control unit 41. For example, the operating unit 42 is used when selecting a medical image, whose automatic approval is to be confirmed, among a list of automatically approved images displayed in the display unit 43.

The display unit 43 is configured with a LCD. The display unit 43 displays various types of screens according to the instructions of display signals which are input from the control unit 41.

The wireless communication unit 44 is for carrying out sending and receiving of data through wireless communication, such as Wi-Fi (Wireless Fidelity) communication, with an external device connected to the communication network N. The wireless communication unit 44 is, for example, realized by an antenna, a RF converter or the like which performs sending and receiving of wireless signals via a wireless communication base station established by a communication service provider. As for the wireless communication unit 44, it is sufficient that wireless communication can be carried out with the medical image management apparatus 2, and an infrared data communication (IrDA/IrMC), Bluetooth (registered trademark) or the like may be used.

The RAM 45 functions as a work area for temporarily storing various types of programs read from the storage unit 46 that can be executed by the control unit 41, input and output data and the like in various processing which are executed and controlled by the control unit 41.

The storage unit 46 is configured with a HDD (Hard Disk Drive) memory or a non-volatile memory such as a semiconductor memory, etc. In the storage unit 46, various types of programs, data necessary for various processes and the like are stored. For example, in the storage unit 46, the application program P2 is stored.

If an unapproved medical image (hereinafter referred to as an unapproved image) exists among the medical images which are stored in the storage unit 26 according to the image import instruction from a certain client terminal 4, the control unit 41 of the client terminal 4 automatically approves the unapproved image. That is, the control unit 41 functions as an automatic approval unit.

In particular, a control unit 41 makes an inquiry to the medical image management apparatus 2 via the wireless communication unit 44 whether an unapproved image exists among the medical images which are imported from the image generation apparatus 3 according to the image import instruction from the client terminal 4 which the control unit 41 belongs to. If an unapproved image exists, the control unit 41 sends an instruction to change the field of “automatically approved flag” to be “1: automatic approval” with respect to the record of the unapproved image in the image management table T2 to the medical image management apparatus 2 via the wireless communication unit 44.

The control unit 41 notifies the information indicating the existence of an automatically approved image if an automatically approved image exists among the medical images which are stored in the storage unit 26 according to the image import instruction from the client terminal 4 which the control unit 41 belongs to. That is, the control unit 41 functions as a notification unit.

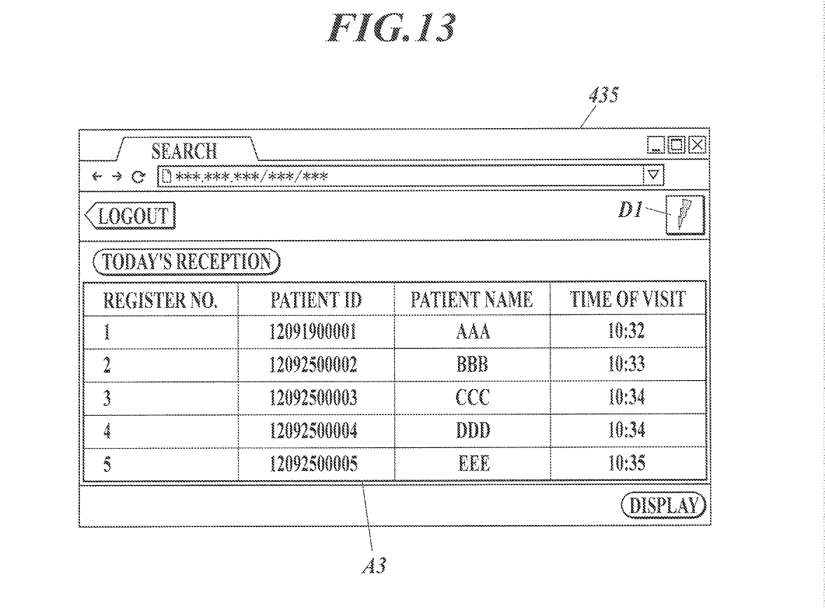

In particular, the control unit 41 makes an inquiry to the medical image management apparatus 2 via the wireless communication unit 44 whether an automatically approved image exists among the medical images which are stored in the storage unit 26 according to the image import instruction from the client terminal 4 which the control unit 41 belongs to. If an automatically approved image exists, the control unit 41 makes the display unit 43 display the warning icon D1 (see FIG. 13) which indicates the existence of the automatically approved image.

If an automatically approved image exists among the medical images which are stored in the storage unit 26 according to the image import instruction from the client terminal 4 which the control unit 41 belongs to, the control unit 41 makes the display unit 43 display the list of automatically approved images. That is, the control unit 41 functions as a display control unit.

With respect to a medical image which is automatically approved, the control unit 41 sends an instruction to store the image in the storage unit 26 so as to be associated with the information indicating the automatic approval of the medical image (“1: confirmed” in the field of “confirmed/not-confirmed” in the image management table T2) to the medical image management apparatus 2 via the wireless communication unit 44. That is, the control unit 41 functions as a reconfirmation unit.

The medical image whose automatic approval is confirmed is not relevant for notification of the information indicating the existence of automatically approved image and is not to be included in the list of automatically approved images.

### [Operation of Medical Image System]

Next, operation of the medical image system 100 will be described.

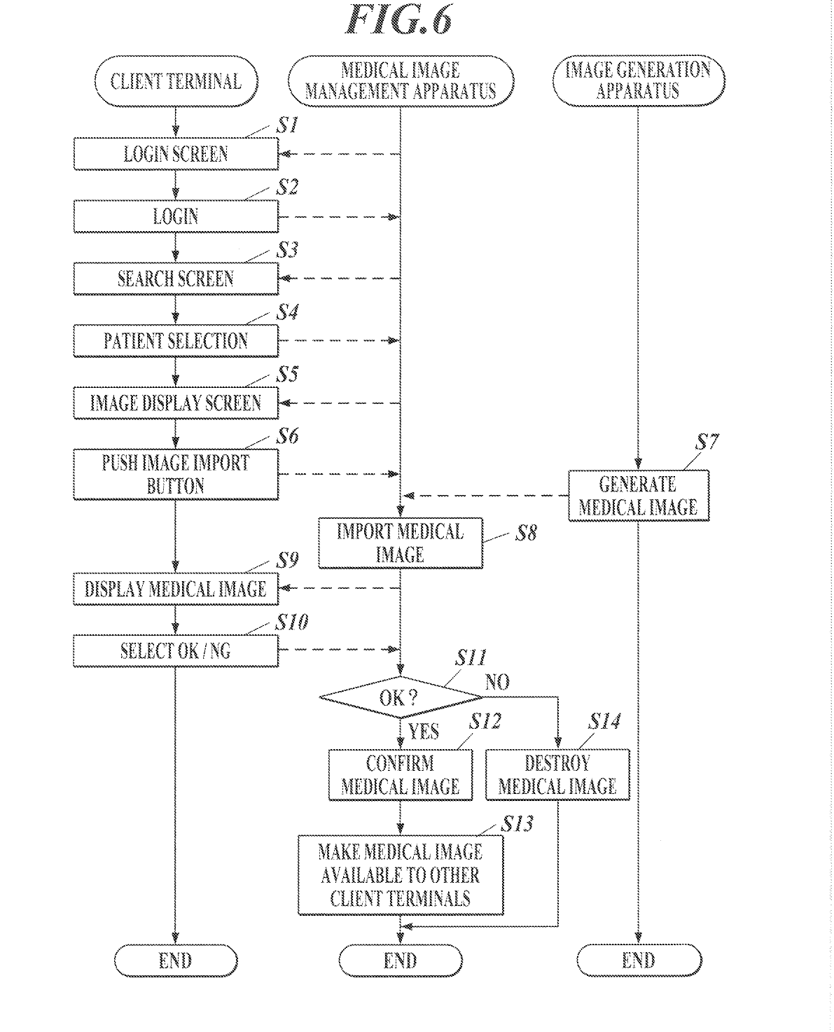

FIG. 6 is a ladder chart showing the image import process performed at normal operation. Processing performed in the medical image management apparatus 2 is realized through the software processing where the control unit 21 and the data management program P1 stored in the storage unit 26 cooperate with each other. Processing performed in the client terminal 4 is realized through the software processing where the control unit 41 and the application program P2 stored in the storage unit 46 cooperate with each other.

First, in any one client terminal 4, the browser is activated according to an operation performed on the operating unit 42 and a predetermined URL (Uniform Resource Locator) for logging in to the medical image system 100 is input from the operating unit 42. Then, the control unit 41 displays the login screen in the display unit 43 (step S1).

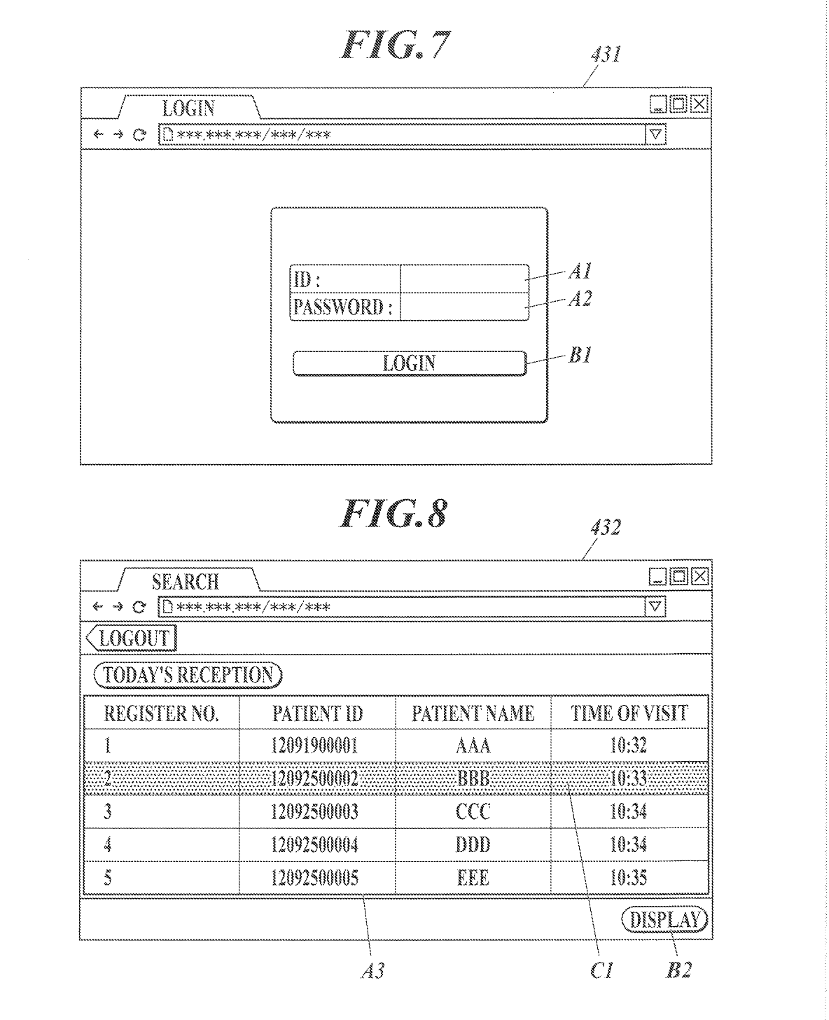

FIG. 7 shows an example of the login screen 431. In the login screen 431, a user ID input section A1, a password input section A2 and a login button B1 are included.

If a user ID and a password are input in the user ID input section A1 and the password input section A2, respectively, and the login button B1 is pushed in the login screen 431 by through operation of the operating unit 42, the control unit 41 sends the user ID, the password and the client terminal name of the client terminal 4 to the medical image management apparatus 2 via the wireless communication unit 44 (step S2). In the medical image management apparatus 2, the communication unit 24 receives the user ID, the password and the client terminal name and the control unit 21 determines whether the combination of the received user ID and password matches a combination of registered user ID and password. If the combination of the received user ID and password matches a combination of registered user ID and password, the control unit 21 allows the user at the client terminal 4 to login.

Next, in the client terminal 4, the control unit 41 obtains patient information of the patients who went through the reception that day from the reception apparatus 1 and displays a search screen (patient list screen) according to the obtained patient information in the display unit 43 (step S3).

FIG. 8 shows an example of the search screen 432. In the search screen 432, a patient list display section A3 and a display button B2 are included. The patient information of the patients who went through the reception process that day is displayed in the patient list display section A3. The display button B2 is a button for instructing to display the image display screen of the patient who is selected in the patient list display section A3.

Here, if a patient who is the target for image capturing is selected among the patients displayed in the patient list display section A3 in the search screen 432 through operation of the operating unit 42 (step S4), the control unit 41 displays the image display screen for displaying an image of the patient who is the target for image capturing in the display unit 43 (step S5).

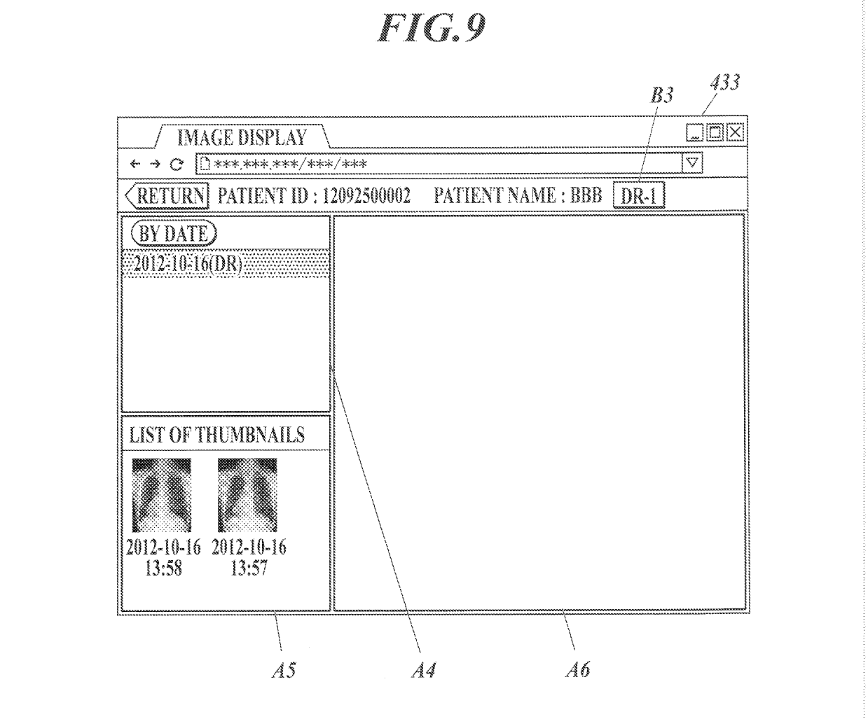

For example, if the patient C1 who is the target for image capturing is selected in the patient list display section A3 in the search screen 432 shown in FIG. 8 and the display button B2 is pushed through operation of the operating unit 42, the control unit 41 sends the patient ID of the patient C1 who is the target for image capturing to the medical image management apparatus 2 via the wireless communication unit 44. Then, the control unit 41 obtains the information relating to the medical image of the selected patient C1 who is the target for image capturing from the medical image management apparatus 2. Thereafter, the image display screen 433 of the selected patient C1 who is the target for image capturing is displayed as shown in FIG. 9. In the image display screen 433, an examination list display section A4, a thumbnail image display section A5, an image display section A6 and an image import button B3 are included. In the examination list display section A4, a list of past examinations (captured images) performed on the patient C1 who is the target for image capturing is displayed. In the thumbnail image display section A5, the thumbnail images of the images captured in the examination selected in the examination list display section A4 are displayed. In the image display section A6, the medical image which is instructed to be imported by the client terminal 4 or the diagnosis target image selected among the thumbnail images displayed in the thumbnail image display section A5 is displayed. Here, no image is displayed in the image display section A6 before an image is imported or before a diagnosis target image is selected. The image import button B3 is provided for each image generation apparatus 3. Each image import button B3 is a button for instructing to import the medical image sent from the corresponding image generation apparatus 3 as an image of the patient who currently is the target for diagnosis.

When the image import button B3 corresponding to the image generation apparatus 3 which performs image capturing is pushed through operation of the operating unit 42 in the image display screen 433 (step S6), the control unit 41 sends the instruction (image import instruction) to import the medical image sent from the image generation apparatus 3 corresponding to the pushed image import button B3 as an image of the target patient to the medical image management apparatus 2 via the wireless communication unit 44. When the image import instruction is received by the communication unit 24 in the medical image management apparatus 2, the control unit 21 stores the client terminal name of the client terminal 4 which gave the image import instruction in the field of “client terminal name” in the device management table T1 stored in the storage unit 26 and stores the patient ID of the selected patient in the field of “patient ID” in the device management table T1 stored in the storage unit 26. Thereby, the medical image management apparatus 2 be on standby for importing a medical image which is to be generated in the image generation apparatus 3.

When image capturing of the patient is performed with the image generation apparatus 3 and a medical image is generated (step S7), in the medical image management apparatus 2, the control unit 21 imports the medical image which is sent from the image generation apparatus 2 via the communication unit 24 (step S8). In particular, the control unit 21 stores the medical image which is sent from the image generation apparatus 3 in the storage unit 26 and the control unit 21 stores the client terminal name of the client terminal 4 which gave the image import instruction in the field of “client terminal name” of the image management tablet T2 in the storage unit 26, stores the patient ID of the patient in the field of “patient ID” of the image management table T2, stores the patient name of the patient in the field of “patient name” of the image management table T2, stores the date of image capturing of the medical image in the field of “date of image capturing” of the image management table T2, stores the number of captured medical images in the field of “the number of captured images” of the image management table T2 and stores the file path showing the place where the file of the medical image is stored in the field of “file path” of the image management table T2. Further, the control unit 21 changes the field of “client terminal name” and the field of “patient ID” of the device management table T1 in the storage unit 26 to “NULL”.

Next, in the client terminal 4, the control unit 41 obtains the medical image which is imported from the medical image management apparatus 2 and obtained medical image is displayed in the display unit 43 (step S9).

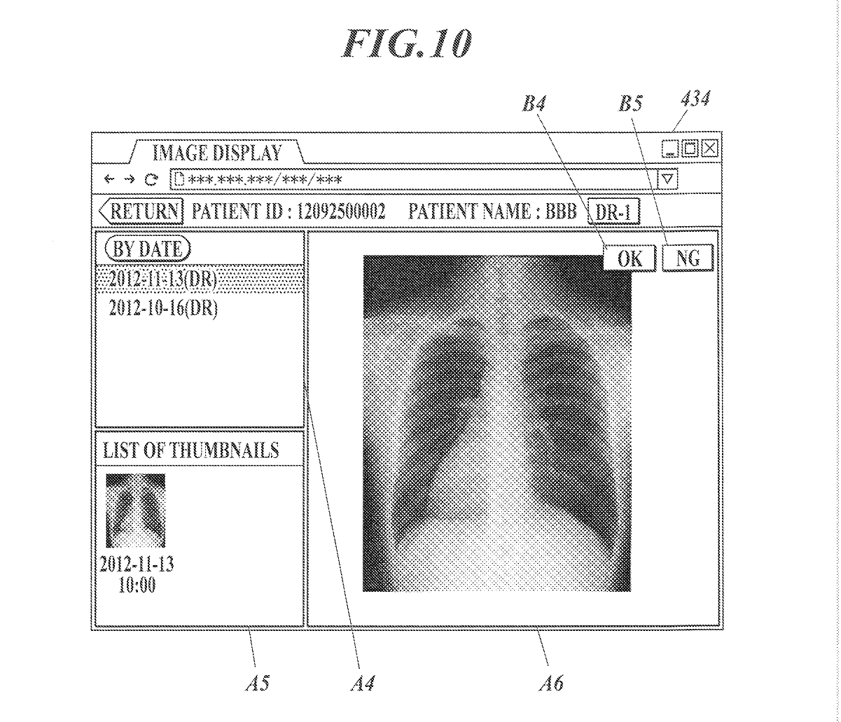

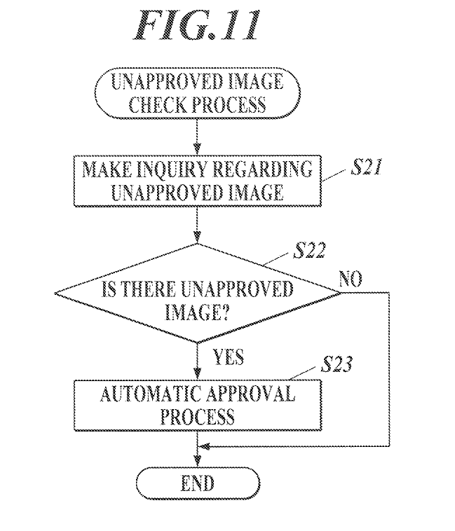

FIG. 10 shows an example of the image display screen 434 where the obtained medical image is displayed. In the image display screen 434, the medical image obtained from the medical image management apparatus 2 is displayed in the image display section A6, and also, the OK button B4 and the NG button B5 for selecting OK/NG are displayed. The OK button B4 is a button for instructing to approve the medical image displayed in the image display section A6. The NG button B5 is a button for instructing to destroy the medical image displayed in the image display section A6.

When a user selects whether the medical image displayed in the display unit 43 is suited for making a diagnosis (OK/NG) (step S10), the control unit 41 sends the selection result, OK or NG, to the medical image management apparatus 2 via the wireless communication unit 44.

In the medical image management apparatus 2, the communication unit 24 receives the selection result, OK or NG, from the client terminal 4. If the selection result is “OK” (step S11; YES), the control unit 21 determines that the medical image is approved (step S12) and, in the image management table T2 in the storage unit 26, the control unit 21 stores “0: OK” in the field of “NG flag” of the target record, stores the “user ID” of the logged in user in the field of “approver” of the target record and stores “NULL” in the field of “client terminal name” of the subject record. That is, from this point further, the medical image which is imported by the control unit 21 in step S8 is made available to other client terminals 4 (step S13).

On the other hand, if the selection result is “NG” (step S11; NO), the control unit 21 destroys the medical image which is imported in step S8 to be eliminated from the storage unit 26 (step S14). Further, the control unit 21 deletes the record related to this medical image from the image management table T2 stored in the storage unit 26.

In the image import process at normal operation shown in FIG. 6, if the communication between the client terminal 4 and the medical image management apparatus 2 is temporarily interrupted (Wi-Fi communication being cutoff, malfunction or breakdown of the router or the like) or if the medical image which is imported in step S8 is left as-is (screen transition and the like due to session timeout) after the medical image is imported in step S8 and before the medical image is approved in step S12 or destroyed in step S14, the imported medical image is to be in an unapproved state.

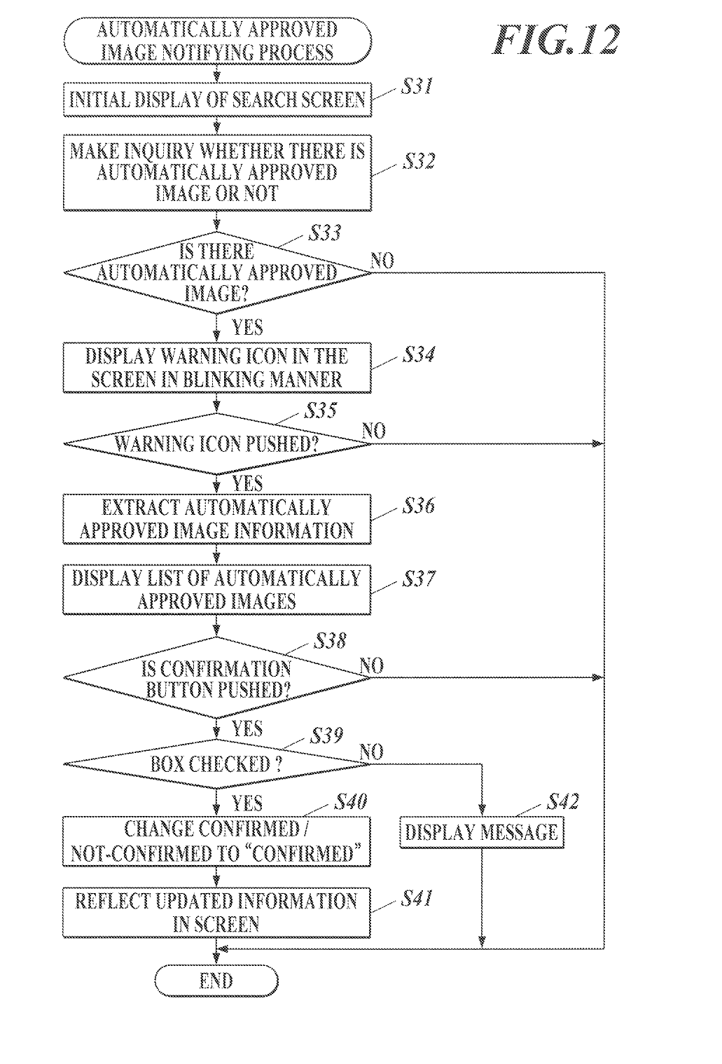

FIG. 11 is a flowchart showing the unapproved image check process executed in the client terminal 4. The unapproved image check process is a process which is to be carried out after login is performed in the login screen (see step S2 in FIG. 6) or after a patient is selected in the search screen (see step S4 in FIG. 6). The unapproved image check process is realized through the software processing where the control unit 41 and the application program P2 stored in the storage unit 46 cooperate with each other.

First, the control unit 41 makes inquiry regarding unapproved image to the medical image management apparatus 2 via the wireless communication unit 44 (step S21). In particular, the control unit 41 makes an inquiry whether the client terminal name of the client terminal 4 which the control unit 41 belongs to exists in the field of “client terminal name” of the image management table T2 stored in the storage unit 26 of the medical image management apparatus 2.

If the client terminal name of the client terminal 4 which made the inquiry exists in the field of “client terminal name” of the image management table T2, in the medical image management apparatus 2, the control unit 21 determines that an unapproved image exists and sends the result indicating “there is unapproved image” to the client terminal 4 via the communication unit 24. On the other hand, if the client terminal name of the client terminal 4 which made the inquiry does not exist in the field of “client terminal name” of the image management table T2, the control unit 21 determines that there is no unapproved image and sends the result indicating “there is no unapproved image” to the client terminal 4 via the communication unit 24.

In the client terminal 4, the wireless communication unit 44 receives the determination result from the medical image management apparatus 2. If the determination result sent from the medical image management apparatus 2 is “there is unapproved image” (step S22; YES), the control unit 41 performs the automatic approval process with respect to the unapproved image (step S23). In particular, the control unit 41 sends an instruction to update the field of “client terminal name”, the field of “NG flag”, the field of “automatically approved flag” (change to “1: automatic approval”), the field of “date of automatic approval” and the field of “approver” in the record of the unapproved image in the image management table T2, that is, in the record having the client terminal name of the client terminal 4 which the control unit 41 belongs to stored in the field of “client terminal name”.

In the medical image management apparatus 2, when the communication unit 24 receives the instruction sent from the client terminal 4, the control unit 21 stores “NULL” in the field of “client terminal name”, stores “0: OK” in the file of “NG flag”, stores “1: automatic approval” in the field of “automatically approved flag”, stores the “current date” obtained by the timer unit 27 in the field of “date of automatic approval” and stores the “user ID” of the user who is logged in at the client terminal 4 in the field of “approver” with respect to the record of the unapproved image in the image management table T2. That is, from this point further, the control unit 21 allows the automatically approved image to be made available to other client terminals 4.

After step S23 or in step S22, if the determination result sent from the medical image management apparatus 2 is “there is no unapproved image” (step S22; NO), the unapproved image check process ends.

FIG. 12 is a flowchart showing the automatically approved image notifying process that is executed in the client terminal 4. The automatically approved image notifying process is a process which is executed after logging in is performed in the login screen (see step S2 in FIG. 6). The automatically approved image notifying process is realized through the software processing where the control unit 41 and the application program P2 stored in the storage unit 46 cooperate with each other.

First, the control unit 41 obtains patient information of the patients who went through the reception process on that day from the reception apparatus 1 and makes the display unit 43 display the initial screen of the search screen according to the obtained patient information (step S31).

Next, the control unit 41 makes an inquiry to the medical image management apparatus 2 via the wireless communication unit 44 whether there is an automatically approved image or not (step S32). In particular, the control unit 41 makes an inquiry whether a record wherein the value stored in the field of “automatically approved flag” is “1: automatic approval” and the date stored in the field of “date of automatic approval” is within a predetermined retention period going back from the current date exists among the records wherein the values stored in the field of “approver” in the image management table T2 stored in the storage unit 26 of the medical image management apparatus 2 are the user ID of the user who is logged in at the client terminal 4. The period for storing the automatically approved image (for example, within 90 days) is preset as the predetermined retention period.

If a record wherein the value stored in the field of “automatically approved flag” is “1: automatic approval” and the date stored in the field of “date of automatic approval” is within a predetermined retention period going back from the current date exists among the records wherein the values stored in the field of “approver” in the image management table T2 are the user ID of the user who is logged in, in the medical image management apparatus 2, the control unit 21 determines that there is an automatically approved image and sends the result indicating “there is automatically approved image” to the client terminal 4 via the communication unit 24. On the other hand, if a record wherein the value stored in the field of “automatically approved flag” is “1: automatic approval” and the date stored in the field of “date of automatic approval” is within a predetermined retention period going back from the current date does not exists among the records wherein the values stored in the field of “approver” in the image management table T2 are the user ID of the user who is logged in, the control unit 21 determines that there is no automatically approved image and sends the result indicating “there is no automatically approved image” to the client terminal 4 via the communication unit 24.

In the client terminal 4, the wireless communication unit 44 receives the determination result sent from the medical image management apparatus 2. If the determination result sent from the medical image management apparatus 2 is “there is automatically approved image” (step S33; YES), the control unit 41 displays the warning icon that indicates existence of an automatically approved image on the search screen displayed in the display unit 43 in a blinking manner (step S34).

FIG. 13 shows an example of the search screen 435. In the search screen 435, the warning icon D1 is displayed in addition to the patient list display section A3. By the warning icon D1 blinking, a user can be alerted.

Here, if the warning icon D1 in the search screen 435 is pushed through operation of the operating unit 42 (step S35; YES), the control unit 41 extracts the information relating to the automatically approved image from the image management table T2 stored in the storage unit 26 of the medical image management apparatus 2 (step S36). In particular, the control unit 41 sends a request to the medical image management apparatus 2 via the wireless communication unit 44 to obtain the record wherein the value stored in the field of “automatically approved flag” is “1: automatic approval” and the date stored in the field of “date of automatic approval” is within a predetermined retention period going back from the current date among the records wherein the values stored in the field of “approver” in the image management table T2 are the user ID of the user who is logged in, and the control unit 41 obtains the information relating to the automatically approved image from the medical image management apparatus 2.

Next, the control unit 41 makes the display unit 43 display a list of extracted automatically approved images (step S37).

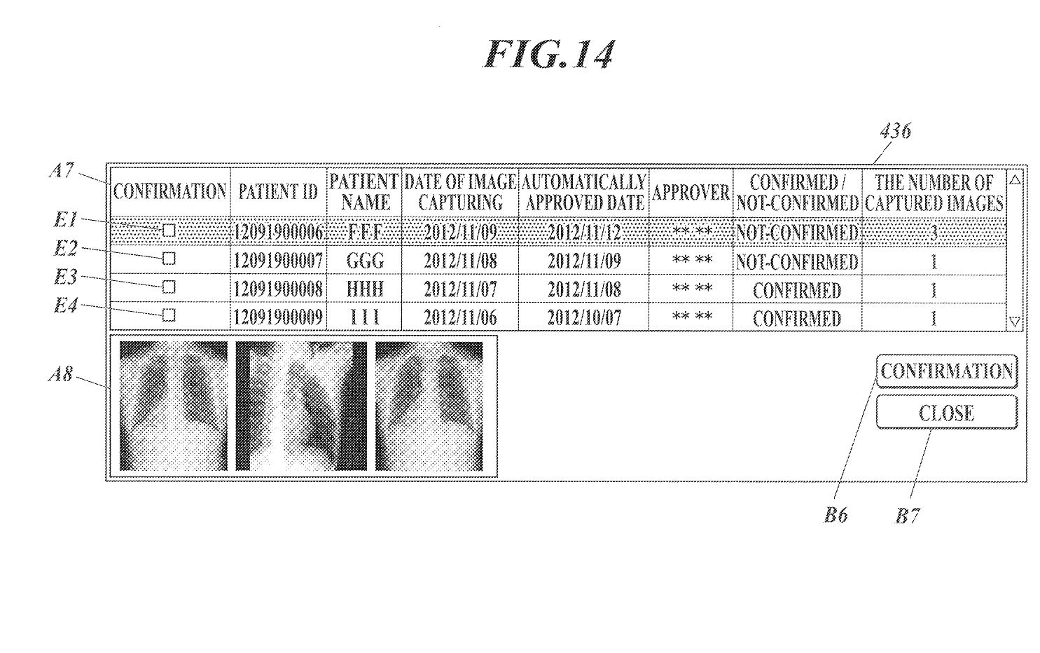

FIG. 14 shows an example of the automatically approved image list screen 436. In the automatically approved image list screen 436, an automatically approved image list display section A7, a thumbnail image display section A8, a confirmation button BE and a close button B7 are included. In the automatically approved image list display section A7, a list of automatically approved images is displayed. In the thumbnail image display section A8, the thumbnail images of the images selected in the automatically approved image list display section A7 are displayed. The confirmation button B6 is a button for instructing to make the automatically approved images whose check boxes E1 to E4 are checked in the automatically approved image list display section A7 be “confirmed”. The close button B7 is a button for instructing to close the automatically approved image list screen 436. A user selects the checkboxes whose automatic approval are confirmed among the checkboxes E1 to E4 corresponding to the images and pushes the confirmation button B6.

If the confirmation button B6 is pushed in the automatically approved image list screen 436 (step S38; YES), the control unit 41 determines whether the checkboxes E1 to E4 in the automatically approved image list display section A7 are checked in the automatically approved image list screen 436 (step S39).

If any of the checkboxes E1 to E4 in the automatically approved image list display section A7 is checked (step S39; YES), the control unit 41 sends the instruction to change the field of “confirmed/not-confirmed” to “confirmed” in the image management table T2 with respect to the record(s) of the automatically approved image(s) whose checkbox is checked to the medical image management apparatus 2 via the wireless communication unit 44 (step S40).

In the medical image management apparatus 2, the communication unit 24 receives the instruction sent from the client terminal 4 and the control unit 21 changes the values in the field of “confirmed/not-confirmed” to “1: confirmed” with respect to the selected record(s) of the automatically approved image(s) in the image management table T2.

With updating of data in the image management table T2, the control unit 41 re-extracts the information relating to the automatically approved image(s) from the image management table T2 stored in the storage unit 26 of the medical image management apparatus 2 and the updated information is reflected in the information on the screen (step S41). For example, in the automatically approved image list screen 436, the images whose checkboxes are checked are deleted from the automatically approved image list display section A7 when the confirmation button B6 is pushed. Further, when there is no more automatically approved image which is on standby to be confirmed, the warning icon D1 disappears from the search screen 435.

If none of the checkboxes E1 to E4 in the automatically approved image list display section A7 is checked in step S39 (step S39; NO), the control unit 41 displays a warning message indicating that there is no image selected in the list shown in the automatically approved image list display section A7 (step S42).

If the determination result sent from the medical image management apparatus 2 is “there is no automatically approved image” in step S33 (step S33; NO), if the warning icon D1 in the search screen 435 is not pushed in step S35 (step S35; NO) and if the confirmation button 36 is not pushed in step S38 (step S38; NO), the automatically approved image notifying process ends after step S41 or after step S42.

As described above, according to the embodiment, if an automatically approved image exists among the medical images which are stored in the storage unit 26 according to the image import instruction from the client terminal 4, information (warning icon) that indicates the existence of automatically approved image is displayed in the display unit 43. Therefore, a user can be alerted.

Further, the automatically approved image is allowed to be viewed by other client terminals 4 in the medical image management apparatus 2, similarly to the normal allowing. Therefore, the automatically approved image can also be made available to other client terminals 4.

Furthermore, the medical images whose automatic approval is to be confirmed can be selected from the list of automatically approved images. Therefore, the automatically approved images can be managed by discriminating them on whether the normal permission (confirmation) is given by a user such as a doctor.

Conventionally, there was very little problem such as the communication being cutoff because the medical image management apparatuses 2 and the client terminals 4 are connected through wired connection in many cases. However, in recent years, due to mobile terminals using wireless communication becoming widely used as the client terminals 4, there is a great risk of the communication being unstable. Therefore, the present invention exhibits greater advantage in systems using wireless communication.

The above description of the embodiment is an example of the medical image system according to the present invention, and the present invention is not limited to the above description. The detail configurations and detail operation of the apparatuses constituting the system can be modified arbitrarily within the scope of the invention.

For example, in the above embodiment, the unapproved image check process is performed after login is performed in the login screen or after a patient is selected in the search screen. However, the “automatically approved flag” in the image management table T2 may be changed to “1: automatic approval” when the medical image management apparatus 2 detects a cutoff in communication with the client terminal 4 or when the medical image(s) which is imported has been left as-is for a predetermined period of time without being approved.

Moreover, in the above embodiment, data communication between the client terminals 4 and the medical image management apparatus 2 is performed in a wireless manner. However, data communication may be performed through wired communication.

Further, the above embodiment describes a case where, if there are a plurality of image generation apparatuses 3, the medical image management apparatus 2 cannot be in on standby for image import with respect to other image generation apparatuses 3 if the medical image management apparatus 2 is already on standby for image import with respect to any one of the image generation apparatuses 3. However, the standby for image import state of the medical image management apparatus 2 may be managed with respect to each image generation apparatus 3.

In the above description, an example where HDD or a non-volatile memory is used as a computer readable medium in which program for executing various processes are stored is shown. However, the computer readable medium is not limited to such example. As other computer readable medium, a portable recording mediums such as CD-ROM, for example, can be used. Further, carrier wave may be applied as a medium for providing data of programs through a communication circuit.

The entire disclosure of Japanese Patent Application No. 2012-265881 filed on Dec. 5, 2012 is incorporate herein by reference in its entirety.

What is claimed is:

1. A medical image system, comprising:
a medical image management apparatus including a storage unit;
a plurality of client terminals; and
an image generation apparatus,
wherein
the medical image management apparatus and the plurality of client terminals are connected to one another to perform data communication therebetween,
the medical image management apparatus and the image generation apparatus are connected to one another to perform data communication therebetween,
the medical image management apparatus includes an image management unit which (i) stores a medical image which is sent from the image generation apparatus in the storage unit according to an image import instruction from each of the plurality of client terminals, (ii) provides the client terminal which gave the image import instruction with the medical image stored in the storage unit, (iii) when an instruction to approve the medical image stored in the storage unit is given from the client terminal which gave the image import instruction, stores information indicating that the medical image is approved in the storage unit so as to be associated with the medical image and allows the medical image which is approved to be viewed by other client terminals,
each of the plurality of client terminals comprises:
an automatic approval unit which, when an unapproved medical image exists among medical images which are stored in the storage unit according to the image import instruction from the client terminal, automatically approves the unapproved medical image; and
a notifying unit which, when the medical image which is automatically approved exists among the medical images which are stored in the storage unit according to the image import instruction from the client terminal, notifies information indication existence of the medical image which is automatically approved.

2. The medical image system of claim 1, wherein
the image management unit stores information indicating automatic approval in the storage unit so as to be associated with the medical image which is automatically approved and allows the medical image which is automatically approved to be viewed by other client terminals.

3. The medical image system of claim 1, wherein each of the plurality of client terminals further comprises:
a display control unit which, when the medical image which is automatically approved exists among the medical images which are stored in the storage unit according to the image import instruction from the client terminal, displays an automatically approved medical image list in a display unit;
an operating unit for selecting a medical image whose automatic approval is to be confirmed among the list displayed in the display unit; and
a reconfirmation unit which sends an instruction to store a medical image whose automatic approval is confirmed in the storage unit so as to be associated with information indicating that the automatic approval of the medial image is confirmed.

4. The medical image system of claim 1, wherein the data communication between the medical image management apparatus and the plurality of client terminals is performed in a wireless manner.
